(19) United States
(12) Patent Application Publication
(10) Pub. No.: US 2025/0357701 A1
(43) Pub. Date: Nov. 20, 2025

(54) CONNECTOR

(71) Applicant: SUMITOMO WIRING SYSTEMS, LTD., Mie (JP)

(72) Inventors: Kyohei IIDA, Mie (JP); Yutaka KOBAYASHI, Mie (JP)

(21) Appl. No.: 18/871,482

(22) PCT Filed: Jun. 5, 2023
(86) PCT No.: PCT/JP2023/020760

§ 371 Date: Dec. 4, 2024

(30) Foreign Application Priority Data
Jun. 8, 2022 (JP) 2022-093253

(51) Int. Cl. H01R 13/533; H01R 13/6581

(52) U.S. Cl. CPC H01R 13/533; H01R 13/6581; H01R 2201/26

(57) ABSTRACT

An outer housing according to an aspect of the present disclosure has a first opening where the mating terminals are inserted along a first direction and a second opening for the wires to pass through along a second direction crossing the first direction. An inner housing is disposed inside the outer housing and holds the terminals therein. One of a first inner housing holder and a second inner housing holder is selectable as an inner housing holder to be attached to the second opening. The first inner housing holder includes a first mounting portion that is fitted into the second opening and a fixed leg that is fixed to a device to which a mating connector is attached. The second inner housing holder includes a second mounting portion fitted into the second opening.

### TECHNICAL FIELD

The present disclosure relates to a connector.

### BACKGROUND

Conventionally, a connector mounted in a vehicle includes an outer housing, an inner housing placed in the outer housing, and a terminal held by the inner housing. One end of a wire is electrically connected to the terminal. A mating connector to be connected to the connector has a mating terminal that is inserted into the connector to be electrically connected to the terminal.

For example, as described in Patent Document 1, a mating terminal is inserted into such a connector along a direction parallel to the extension direction of a wire. The connector described in Patent Document 1 includes a rattle preventing member attached to the opening of an outer housing provided in the connector. When the connector and a mating connector are connected, the mating terminal is inserted into the connector from the opening of the outer housing. The rattle preventing member regulates the movement of the opening relative to the mating connector when the connector is fitted to the mating connector. This can suppress sliding of a contact portion between the terminal and the mating terminal when sliding is caused by vibrations generated in an in-vehicle environment.

### PRIOR ART DOCUMENT

### Patent Document

Patent Document 1: JP 2012-018803 A

### SUMMARY OF THE INVENTION

### Problems to Be Solved

In some cases, a mating terminal is inserted into a connector along a direction crossing the extension direction of a wire. When such a connector is connected to a mating connector fixed to the housing of a device, such a connector advantageously has a smaller protrusion from the surface of the housing than a connector into which a mating terminal is inserted along a direction parallel to the extension direction of a wire. However, when such a connector is used, a wire is disposed in parallel with the surface of the housing of the device. Hence, when the wire is vibrated by vibrations generated in an in-vehicle environment, the vibrations propagate through a contact between the terminal and the mating terminal, so that wear is likely to occur on the terminal and the mating terminal.

Thus, for example, the rattle preventing member described in Patent Document 1 may be added to the connector into which the mating terminal is inserted along a direction crossing the extension direction of a wire. However, the addition of the rattle preventing member to the connector is equivalent to the addition of a component only for providing a vibration-resistant structure to the connector, which may increase the number of components.

In some cases, even if a mating terminal is inserted into a connector along a direction crossing the extension direction of a wire, the connector may be provided without a vibration-resistant structure, for example, when the connector is located remote from the source of vibration in a vehicle.

An object of the present disclosure is to provide a connector in which the presence or absence of a vibration-resistant structure can be selected without increasing the number of components, the connector being configured such that a mating terminal to be connected to a terminal is inserted in a direction crossing the extension direction of a wire.

### Means to Solve the Problem

A connector according to the present disclosure is a connector including an outer housing made of synthetic resin, the outer housing having a first opening where a mating terminal provided on a mating connector is inserted along a first direction and a second opening for a wire to pass through along a second direction crossing the first direction, an inner housing that is made of synthetic resin and is disposed in the outer housing, a terminal that is held in the inner housing and is electrically connected to the wire, the mating terminal being electrically connected to the terminal, and an inner housing holder that is attached to the second opening to hold the inner housing in the outer housing, wherein one of the first inner housing holder and the second inner housing holder is selectable as the inner housing holder, the first inner housing holder includes: a first mounting portion that has a first through hole for the wire to pass through and is fitted into the second opening, and a fixed leg that extends from the first mounting portion to the outside of the outer housing and is fixed to a device, the mating connector being attached to the device, and the second inner housing holder includes a second mounting portion that has a second through hole for the wire to pass through and is fitted into the second opening.

### Effect of the Invention

According to the connector of the present disclosure, the presence or absence of a vibration-resistant structure can be selected without increasing the number of components, the connector being configured such that the mating terminal to be connected to the terminal is inserted in a direction crossing the extension direction of a wire.

### BRIEF DESCRIPTION OF THE DRAWINGS

FIG. 1 is a schematic perspective view illustrating a connector and a mating connector according to an embodiment.

FIG. 2 is a schematic plan view of the connector illustrated in FIG. 1.

FIG. 3 is a schematic cross-sectional view of the connector and the mating connector that are illustrated in FIG. 1.

FIG. 4 is a schematic cross-sectional view illustrating an enlarged part of the connector and the mating connector that are illustrated in FIG. 1.

FIG. 5 is a schematic cross-sectional view illustrating an enlarged part of the connector and the mating connector that are illustrated in FIG. 1.

FIG. 6 is a schematic perspective view of the mating connector illustrated in FIG.

FIG. 7 is a schematic perspective view of the connector illustrated in FIG. 1.

FIG. 8 is a schematic perspective view of the connector illustrated in FIG. 1.

FIG. 9 is a schematic exploded perspective view of a shield shell, an inner housing, and terminals with connected wires provided in the connector illustrated in FIG. 1.

FIG. 10 is a schematic side view illustrating an electromagnetic shield structure provided in the connector and the mating connector that are illustrated in FIG. 1.

FIG. 11 is a schematic exploded perspective view of the connector illustrated in FIG. 1.

FIG. 12 is a schematic perspective view of a first inner housing holder provided in the connector illustrated in FIG. 1.

FIG. 13 is a schematic perspective view of the connector illustrated in FIG. 1, the connector including a second inner housing holder.

FIG. 14 is a schematic exploded perspective view of the connector illustrated in FIG. 13.

FIG. 15 is a schematic perspective view of the second inner housing holder provided in the connector illustrated in FIG. 13.

FIG. 16 is a schematic cross-sectional view of the connector illustrated in FIG. 13.

### DETAILED DESCRIPTION TO EXECUTE THE INVENTION

### Description of Embodiment of Present Disclosure

An embodiment of the present disclosure will be first described in list form.

[1] A connector according to the present disclosure is: a connector including an outer housing made of synthetic resin, the outer housing having a first opening where a mating terminal provided on a mating connector is inserted along a first direction and a second opening for a wire to pass through along a second direction crossing the first direction, an inner housing that is made of synthetic resin and is disposed in the outer housing, a terminal that is held in the inner housing and is electrically connected to the wire, the mating terminal being electrically connected to the terminal, and an inner housing holder that is attached to the second opening to hold the inner housing in the outer housing, wherein one of a first inner housing holder and a second inner housing holder is selectable as the inner housing holder, the first inner housing holder includes: a first mounting portion that has a first through hole for the wire to pass through and is fitted into the second opening, and a fixed leg that extends from the first mounting portion to the outside of the outer housing and is fixed to a device, the mating connector being attached to the device, and the second inner housing holder includes a second mounting portion that has a second through hole for the wire to pass through and is fitted into the second opening.

With this configuration, when the first inner housing holder is selected as the inner housing holder, the fixed leg can be fixed to the device. Specifically, the first inner housing holder attached to the second opening for the wires to pass through can be fixed to the device. When the fixed leg is fixed to the device, the outer housing having the attached first inner housing holder and the inner housing disposed inside the outer housing are integrated with the device and thus are difficult to move relative to the device. This can suppress vibrations of the outer housing and the inner housing when the vibrations are caused by the vibrations of the wires. When the connector and the mating connector are connected to each other, vibrations of the wires are restrained from causing a relative movement of the terminals, which are held in the inner housing, and the mating terminals. This can suppress wearing of the contact portion between the terminals and the mating terminals. As described above, when the first inner housing holder is selected as the inner housing holder, the connector can be provided with a vibration-resistant structure.

The first inner housing holder is a component obtained by adding the function of providing the connector having a vibration-resistant structure to a component having the function of holding the inner housing in the outer housing. In other words, the first inner housing holder is not a component only for providing the connector with a vibration-resistant structure. Therefore, an increase in the number of components can be suppressed as compared with the case where a component only for providing the connector with a vibration-resistant structure is added to the connector.

Furthermore, the second inner housing holder does not include the fixed leg. Thus, the connector can be manufactured without a vibration-resistant structure by selecting the second inner housing holder as the inner housing holder.

Accordingly, in the connector configured such that the mating terminals to be connected to the terminals are inserted in a direction crossing the extension direction of the wires, the presence or absence of a vibration-resistant structure can be selected without increasing the number of components.

[2] In [1], the first inner housing holder may be made of metal. With this configuration, the first inner housing holder can have greater rigidity as compared with the first inner housing holder made of synthetic resin. This can further suppress vibrations of the outer housing and the inner housing when the vibrations are caused by the vibrations of the wires. When the connector and the mating connector are connected to each other, vibrations of the wires can be further restrained from causing a relative movement of the terminals, which are held in the inner housing, and the mating terminals.

[3] In [2], the first inner housing holder is formed by aluminum die casting. With this configuration, the first inner housing holder made of metal can be easily manufactured.

[4] In any one of [1] to [3], the second inner housing holder may be made of synthetic resin. With this configuration, the second inner housing holder can be inexpensively manufactured with light weight as compared with the case of the second inner housing holder being made of metal.

[5] In [2] or [3], a shield shell that has conductivity and covers the outer surface of the inner housing may be further provided, and the first inner housing holder may have a contact portion that is electrically connected to the shield shell by making contact with the shield shell. With this configuration, when the first inner housing holder is selected as the inner housing holder, the first inner housing holder and the shield shell are electrically connected to each other. When the housing of the device where the mating connector is attached has conductivity, the first inner housing holder and the housing can be electrically connected to each other by fixing the fixed leg in contact with the housing. Thus, the shield shell can be electrically connected to the housing via the first inner housing holder.

[6] In any one of [1] to [5], the fixed leg may have fixing holes for fastening members to pass through, the fastening members fixing the fixed leg to the device, and the fixing holes may be provided on both sides of the outer housing in a direction orthogonal to the second direction when viewed in the first direction. With this configuration, the first inner housing holder can be stably fixed to the device as compared with the case of the single fixing hole or the case of the fixing holes provided only on one side of the outer housing in a direction orthogonal to the second direction when viewed in the first direction. This can further suppress vibrations of the outer housing and the inner housing when the vibrations are caused by the vibrations of the wires. When the connector and the mating connector are connected to each other, vibrations of the wires can be further restrained from causing a relative movement of the terminals, which are held in the inner housing, and the mating terminals.

[7] In any one of [1] to [6], the first mounting portion may be placed in the range of the width of the fixed leg in the second direction. With this configuration, the width of the first inner housing holder can be reduced in the second direction as compared with the case where the first mounting portion is placed out of the range of the width of the fixed leg in the second direction. Thus, upsizing of the connector can be suppressed in the second direction.

[8] In any one of [1] to [7], a first seal member may be further provided for sealing between the inner surface of the first through hole or the inner surface of the second through hole and the outer surface of the wire. With this configuration, the first seal member can provide sealing separately between the outer surface of the wire and the inner surface of the first through hole or the second through hole.

[9] In [8], the outer housing may have a cylindrical shape extending in the second direction and have a first end and a second end located opposite to the first end in the second direction, the first end may be closed, the second opening may be located on the second end, the first opening may be located between the first end and the second end, and a second seal member may be further provided for sealing between the outer surface of the first mounting portion or the outer surface of the second mounting portion and the inner surface of the outer housing. With this configuration, the second seal member can restrain liquids such as water from entering the inside of the outer housing from a portion between the outer surface of the first mounting portion or the second mounting portion and the inner surface of the outer housing.

[10] In [9], the wire may be a shield wire including a core wire, a first insulating coating covering the outer periphery of the core wire, an electromagnetic shield member that has conductivity and covers the outer periphery of the first insulating coating, and a second insulating coating covering the outer periphery of the electromagnetic shield member, the connector may further include a shield shell that has conductivity and covers the outer surface of the inner housing, the electromagnetic shield member may be electrically connected to the shield shell, and in the internal space of the outer housing, an electrically connected portion between the electromagnetic shield member and the shield shell may be disposed at a location where the second seal member restrains entry of liquid from the second opening. With this configuration, the adhesion of liquids such as water to the electrically connected portion between the electromagnetic shield member and the shield shell can be suppressed.

[11] In [9] or [10], the connector may further includes a third seal member that is interposed between the outer housing and the mating connector and restrains liquid from entering the inside of the outer housing from the first opening, and in the internal space of the outer housing, an electrically connected portion between the electromagnetic shield member and the shield shell may be disposed at a location where the third seal member restrains entry of liquid from the first opening. With this configuration, the adhesion of liquids such as water to the electrically connected portion between the electromagnetic shield member and the shield shell can be further suppressed.

### Detailed Description of Embodiment of Present Disclosure

A specific example of a connector according to the present disclosure will be described below with reference to the accompanying drawings. In the drawings, some configurations may be exaggerated or simplified for convenience of explanation. Moreover, the scale ratios of parts may vary among the drawings. The drawings illustrate the x-axis, the y-axis, and the z-axis that are orthogonal to one another. “Orthogonal” in the present specification means nearly orthogonal within the scope of the working-effect of the present embodiment as well as strictly orthogonal. Moreover, “cylindrical” in the present specification includes a cylindrical shape as a combination of multiple parts as well as a circumferentially continuous wall. “Cylindrical” in the present specification includes a spherical outer edge, a circular outer edge, and a polygonal outer edge and refers to an outer edge in any enclosed shape connected by a straight line or a curve. Furthermore, “annular” used in the present specification may refer to any structure like a loop, that is, a continuous shape having no ends and a structure entirely loop-shaped with a gap like a letter C. “Annular” shapes include, but not limited to, a circle, an ellipse, and a polygon having a pointed or round corner. Moreover, terms such as “first,” “second,” and “third” in the present specification are used merely for distinction between objects and are not aimed at ranking the objects. Furthermore, a phrase “at least one” used in the present specification means “one or more” of desired alternatives. For example, when the number of alternatives is two, a phrase “at least one” used in the present specification means “only one alternative” or “both of two alternatives.” As another example, when the number of alternatives is three or more, a phrase “at least one” used in the present specification means “only one alternative” or “a combination of any two or more alternatives.” The present invention is not limited to these illustrations and is intended to include meanings equivalent to the claims and all changes in the scope.

An embodiment of a connector will be described below.

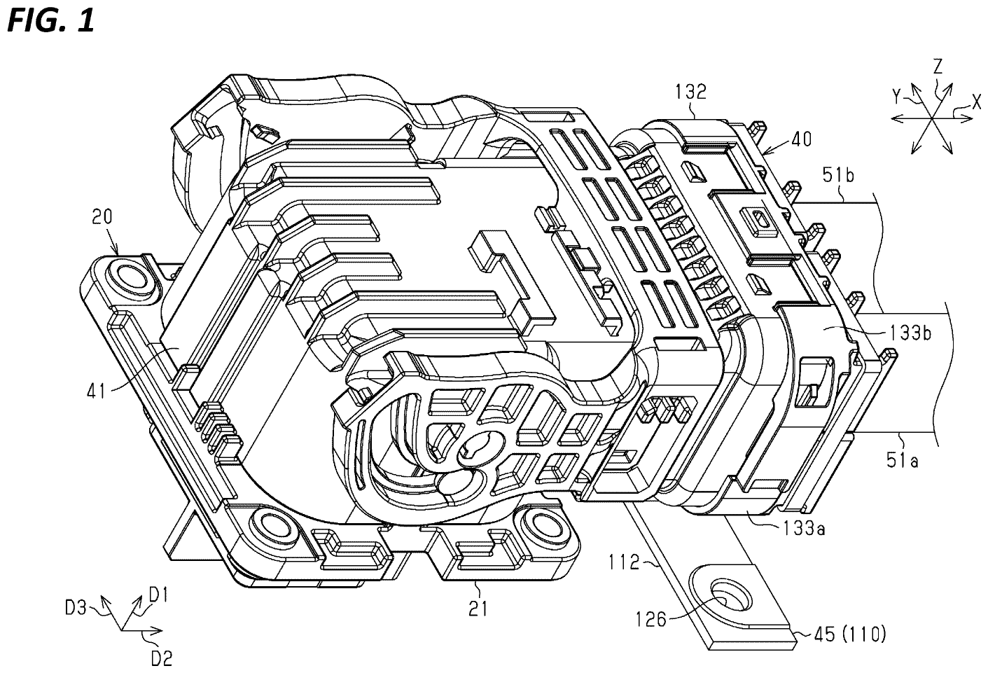

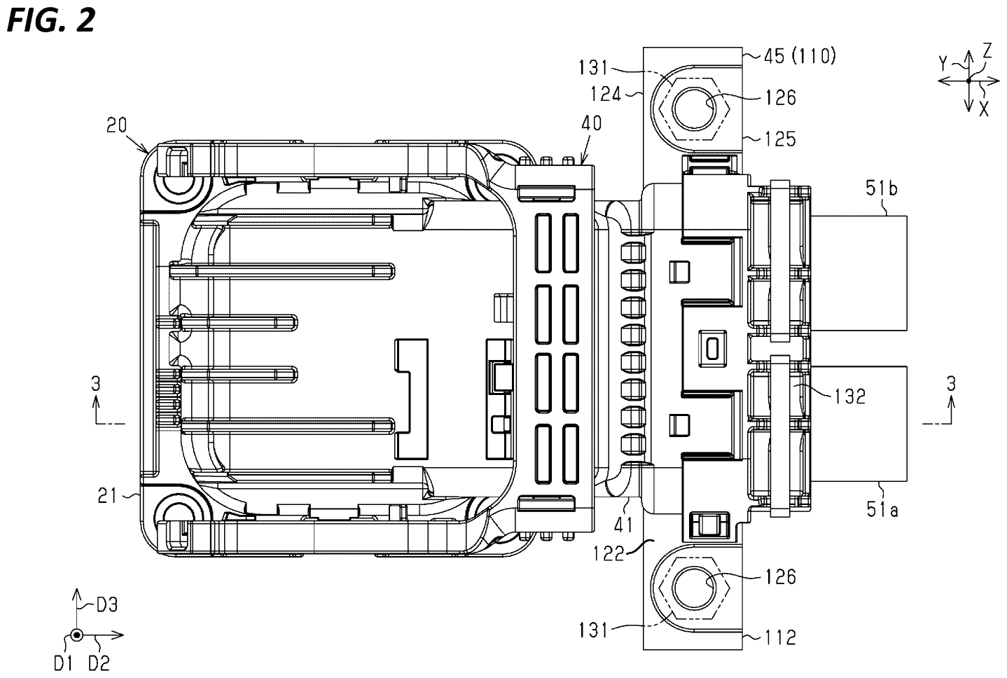

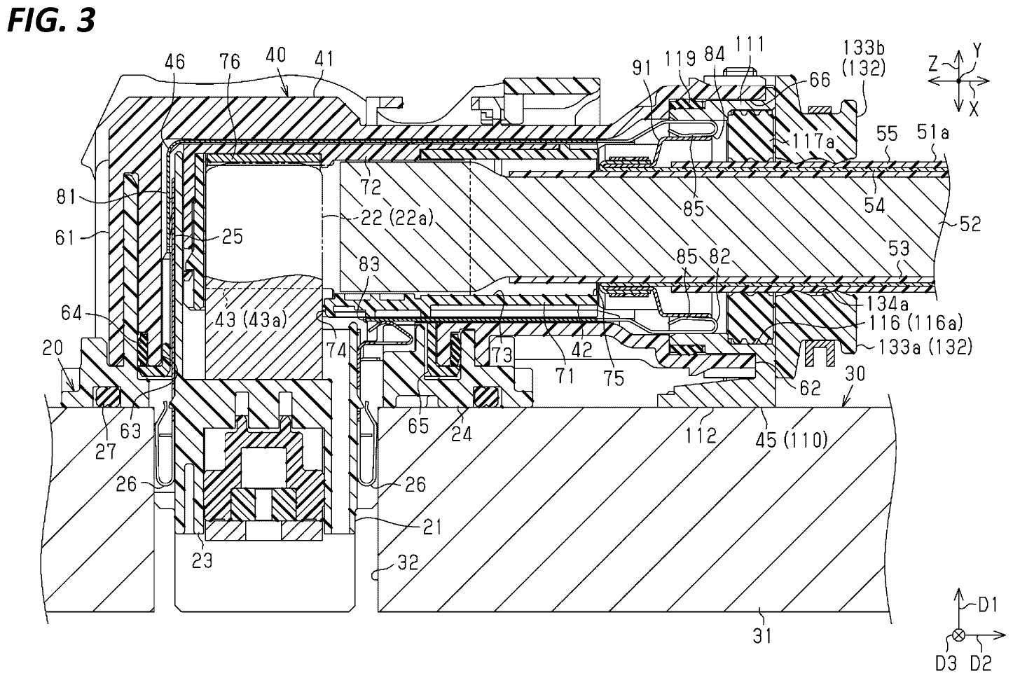

As illustrated in FIGS. 1 to 3, a connector 40 is provided on one end of a wire harness. FIG. 3 is a cross-sectional view taken along line 3-3 of FIG. 2. The connector 40 is detachably connected to a mating connector 20. The connector 40 and the mating connector 20 are disposed in a vehicle. The vehicle includes, for example, a plurality of devices such as a high-voltage battery, an inverter, and a motor for driving wheels. The mating connector 20 is attached to a device 30 that is one of the devices. The device 30 is, for example, an inverter. The device 30 has a housing 31. For example, the housing 31 has conductivity.

### Configuration of Mating Connector 20

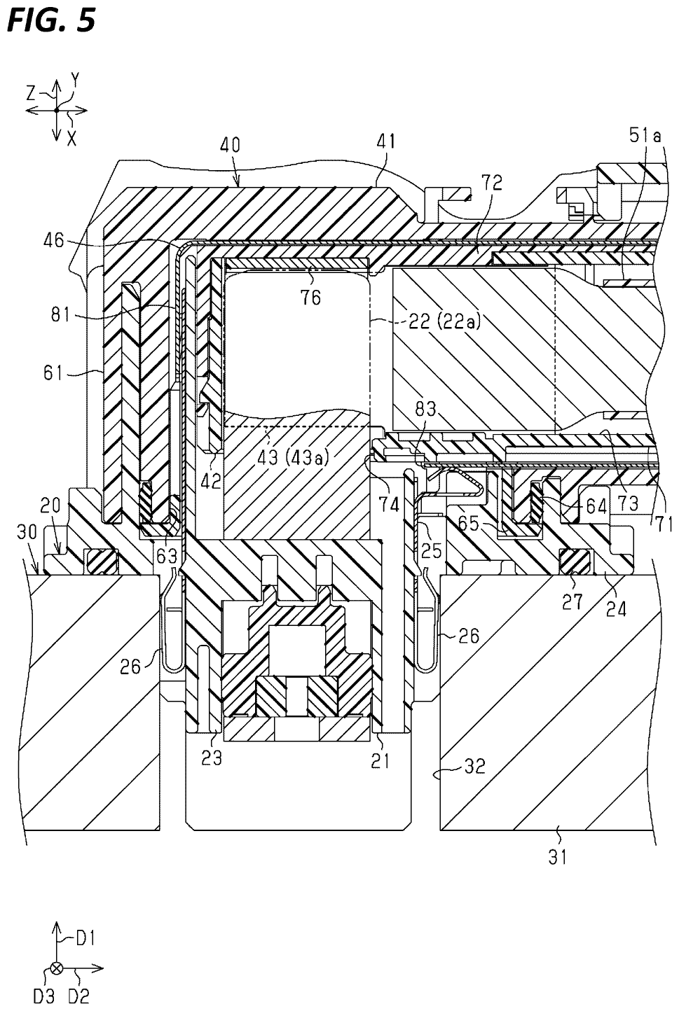

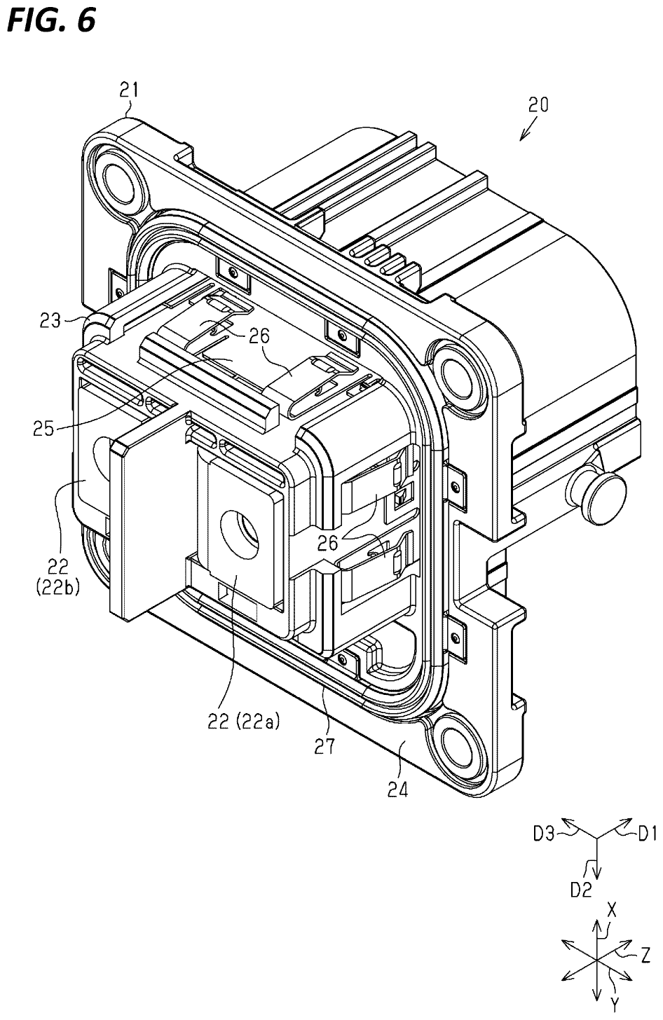

As illustrated in FIGS. 5 and 6, the mating connector 20 includes a mating connector housing 21 and a mating terminal 22. FIG. 5 is a partially enlarged view of FIG. 3. Hereinafter, the mating connector housing 21 will be referred to as “mating housing 21.” The mating connector 20 includes, for example, two mating terminals 22: mating terminals 22a and 22b. The mating terminals 22a and 22b of the mating connector 20 are inserted into the connector 40 along a first direction D1. The first direction D1 is, for example, a direction extending along the z-axis.

The mating housing 21 is made of, for example, synthetic resin. For example, the mating housing 21 includes a body part 23 extending along the first direction D1 and a fixed part 24 extending from the outer surface of the body part 23 to the outside of the body part 23. The body part 23 and the fixed part 24 are integrally molded. For example, the fixed part 24 is shaped like a collar.

The mating terminals 22a and 22b are held inside the body part 23. For example, the mating terminals 22a and 22b are made of metallic materials such as copper, a copper alloy, aluminum, and an aluminum alloy.

The mating connector 20 may further include a mating shield shell 25. Hereinafter, the mating shield shell 25 will be referred to as “mating shell 25.” For example, the mating shell 25 is held inside the body part 23. The mating shell 25 has, for example, a cylindrical shape extending along the first direction D1. The mating shell 25 surrounds the mating terminals 22a and 22b. In other words, the mating terminals 22a and 22b are disposed inside the mating shell 25. The mating shell 25 is made of a conductive material. For example, the mating shell 25 is formed by pressing a metallic plate.

The mating shell 25 may include one or more contact portions 26 in contact with the housing 31. The position of the contact portion 26 in the z-axis direction is shifted in the direction opposite to the first direction D1 with respect to the position of the fixed part 24 in the z-axis direction. The contact portions 26 are formed by folding portions of an end region in the direction opposite to the first direction D1 on the mating shell 25 to the outside of the mating shell 25. The contact portions 26 are elastically deformable.

The housing 31 has a mounting hole 32 for mounting the mating connector 20. The mounting hole 32 passes through the housing 31 to the outside. The mating connector 20 is disposed with a portion protruding opposite to the first direction DI from the fixed part 24 in the mating connector 20 such that the portion is inserted into the mounting hole 32 from the outside of the housing 31. For example, the mating connector 20 is attached to the device 30 by fixing the fixed part 24 to the housing 31 with bolts or screws. The mating connector 20 may include a seal member 27 interposed between the outer surface of the housing 31 and the fixed part 24. The seal member 27 has an annular shape surrounding the body part 23 when viewed in the first direction D1. The seal member 27 restrains liquids such as water from entering the inside of the housing 31 from the mounting hole 32.

### Configuration of Connector 40

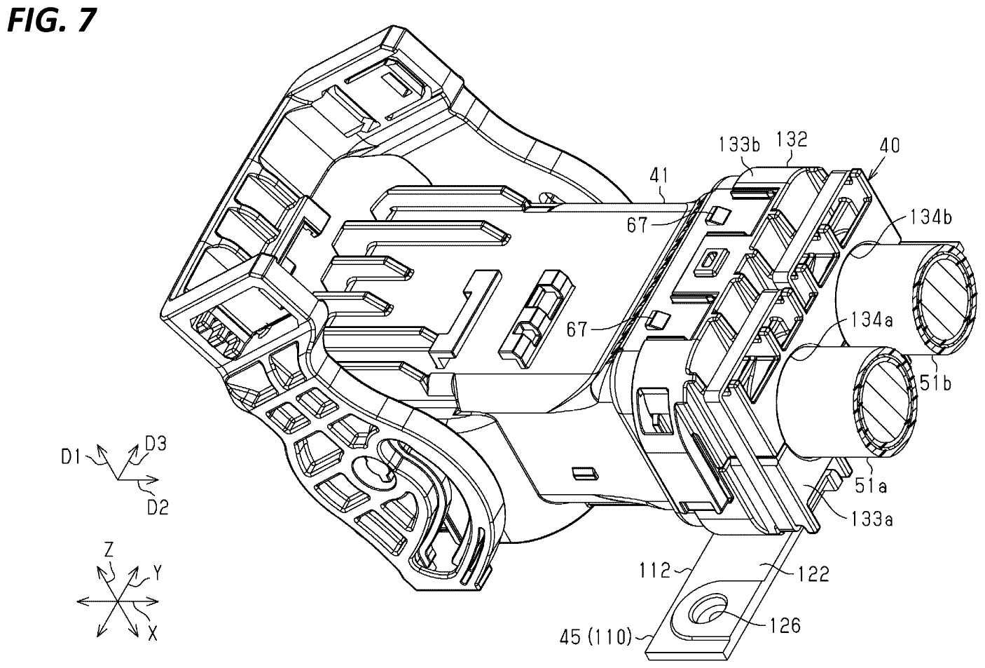

As illustrated in FIGS. 3 and 7, the connector 40 includes an outer housing 41, an inner housing 42, a terminal 43, and an inner housing holder 45. Hereinafter, the outer housing 41 will be referred to as “outside housing 41,” the inner housing 42 will be referred to as “inside housing 42,” and the inner housing holder 45 will be referred to as “inside housing holder 45.” Moreover, the connector 40 may further include a shield shell 46. For example, the connector 40 includes the two terminals 43 that are a terminal 43a and a terminal 43b. The ends of wires 51a and 51b are electrically connected to the terminals 43a and 43b, respectively.

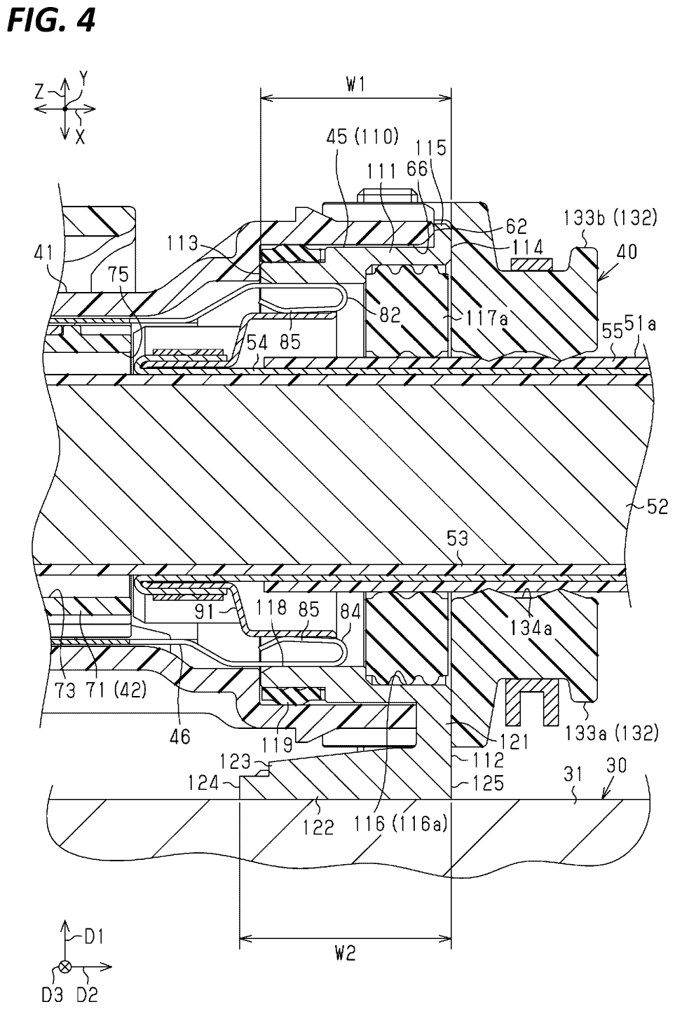

As illustrated in FIG. 4, the wires 51a and 51b are, for example, shield wires having electromagnetic shield structures. FIG. 4 is a partially enlarged view of FIG. 3. FIG. 4 illustrates only the wire 51a. For example, the wire 51a and the wire 51b have the same configuration. The wires 51a and 51b each include, for example, a core wire 52 composed of a conductor, a first insulating coating 53 covering the outer periphery of the core wire 52, an electromagnetic shield member 54 covering the outer periphery of the first insulating coating 53, and a second insulating coating 55 covering the outer periphery of the electromagnetic shield member 54. The wires 51a and 51b are, for example, high voltage cables allowing handling of high voltages and large currents. For example, wires with the core wire 52 having a cross-sectional area of 95 mm² or more may be used as the wires 51a and 51b. Metallic materials such as copper and aluminum can be used as the material of the core wire 52. The first insulating coating 53 and the second insulating coating 55 are made of, for example, an insulating material such as synthetic resin. The electromagnetic shield member 54 is, for example, a braided wire formed by cylindrically braiding conductive element wires made of a copper alloy or an aluminum alloy. The wires 51a and 51b may be unshielded wires having no electromagnetic shield structures.

The wires 51a and 51b extend along a second direction D2 crossing the first direction D1. Specifically, the connector 40 is a connector configured such that the mating terminals 22a and 22b to be connected to the terminals 43a and 43b are inserted in a direction crossing the extension direction of the wires 51a and 51b. The second direction D2 is, for example, a direction orthogonal to the first direction D1. The second direction D2 is, for example, a direction extending along the x-axis. Furthermore, a direction orthogonal to the first direction D1 and the second direction D2 is denoted as a third direction D3. The third direction D3 is, for example, a direction extending along the y-axis. Hereinafter, unless otherwise specified, the first direction D1, the second direction D2, and the third direction D3 are directions set in a state in which the connector 40 is assembled.

### Configuration of Outer Housing 41

As illustrated in FIG. 3, the outside housing 41 constitutes the outer shell of the connector 40. The outside housing 41 is made of synthetic resin. The outside housing 41 has a cylindrical shape to extend in the second direction D2. The outside housing 41 has a first end 61 and a second end 62 located opposite to the first end 61 in the second direction D2. The first end 61 of the outside housing 41 is closed.

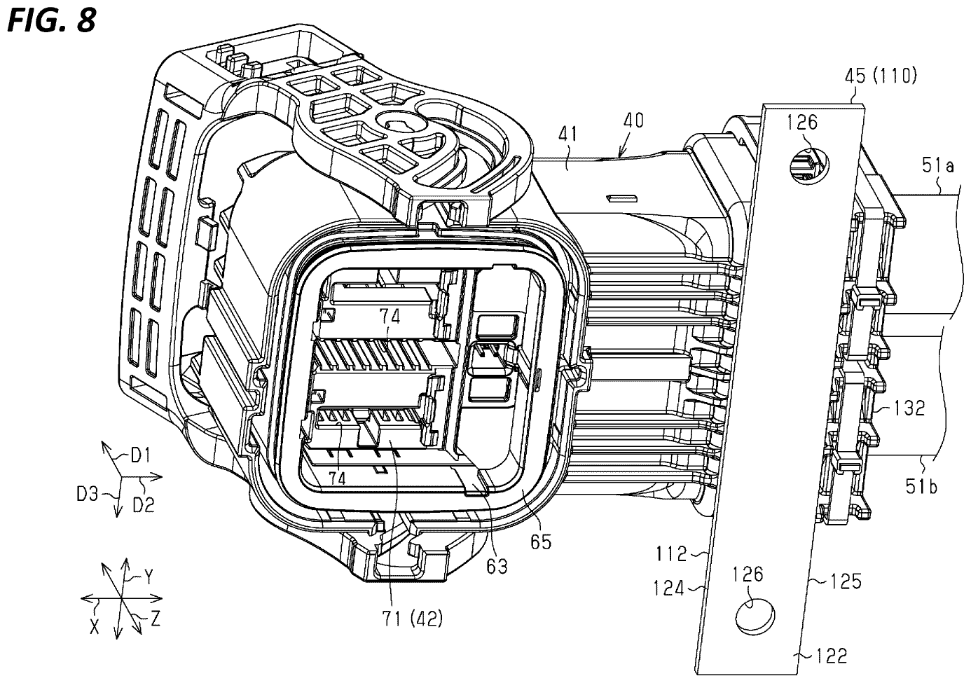

As illustrated in FIGS. 5 and 8, the outside housing 41 has a first opening 63 where the mating terminals 22a and 22b provided on the mating connector 20 are inserted in the first direction D1. The first opening 63 is located between the first end 61 and the second end 62 in the y-axis direction. For example, the position of the first opening 63 in the y-axis direction is shifted in the direction opposite to the second direction D2 with respect to the center of the outside housing 41 in the y-axis direction.

The connector 40 may further include a third seal member 64 interposed between the outside housing 41 and the mating connector 20. For example, the third seal member 64 is disposed around the outer periphery of the first opening 63 in the outside housing 41. The third seal member 64 has, for example, an annular shape surrounding the outer periphery of the first opening 63 when viewed in the first direction D1. The third seal member 64 provides sealing between the connector 40 and the mating housing 21. The third seal member 64 further restrains liquids such as water from entering the inside of the outside housing 41 from the first opening 63. The third seal member 64 is, for example, a rubber ring. A cap 65 that is frame-shaped along the inner edge of the first opening 63 may be attached to the first opening 63.

As illustrated in FIG. 3, the outside housing 41 has a second opening 66 for the wires 51a and 51b to pass through along the second direction D2. The second opening 66 is located on the second end 62 of the outside housing 41. The first opening 63 and the second opening 66 pass through the outside housing 41 to the outside.

### Configuration of Inner Housing 42

The inside housing 42 is disposed inside the outside housing 41. The inside housing 42 is inserted into the outside housing 41 from the second opening 66 in the direction opposite to the second direction D2. The inside housing 42 is held by the outside housing 41 to disable a relative movement of the outside housing 41 and the inside housing 42 in the first direction D1 and the third direction D3. The inside housing 42 is made of synthetic resin. The inside housing 42 includes, for example, an inner housing body 71 and a lid member 72. Hereinafter, the inner housing body 71 will be referred to as “inside housing body 71.”

As illustrated in FIGS. 3 to 5, the inside housing body 71 has a storage recess portion 73 that stores the terminals 43a and 43b. For example, the storage recess portion 73 is recessed in the direction opposite to the first direction D1. The storage recess portion 73 is opened in the first direction D1. The inside housing body 71 has terminal insertion openings 74 at the bottom of the storage recess portion 73. For example, the inside housing body 71 has the two terminal insertion openings 74 as many as the terminals 43a and 43b. The terminal insertion openings 74 pass through the bottom of the storage recess portion 73 in the first direction DI. As illustrated in FIG. 8, the terminal insertion openings 74 are exposed to the outside of the connector 40 from the first opening 63. The mating terminals 22a and 22b inserted from the first opening 63 into the connector 40 are inserted into the inside housing 42 through the respective terminal insertion openings 74.

As illustrated in FIGS. 3 and 4, one end of the inside housing body 71 in the second direction D2 has a wire through hole 75 for the wires 51a and 51b to pass through. The wire through hole 75 is opened in the second direction D2. Moreover, the inside housing body 71 has retaining protrusions, which are not illustrated, from the inner surface of the storage recess portion 73 to the inside of the storage recess portion 73. For example, the inside housing body 71 has the two retaining protrusions as many as the terminals 43aand 43b. The two retaining protrusions come into contact with the terminals 43a and 43b to be placed into the storage recess portion 73, respectively, from the direction opposite to the second direction D2. This restrains the terminals 43a and 43b from moving toward the wire through hole 75 along the second direction D2.

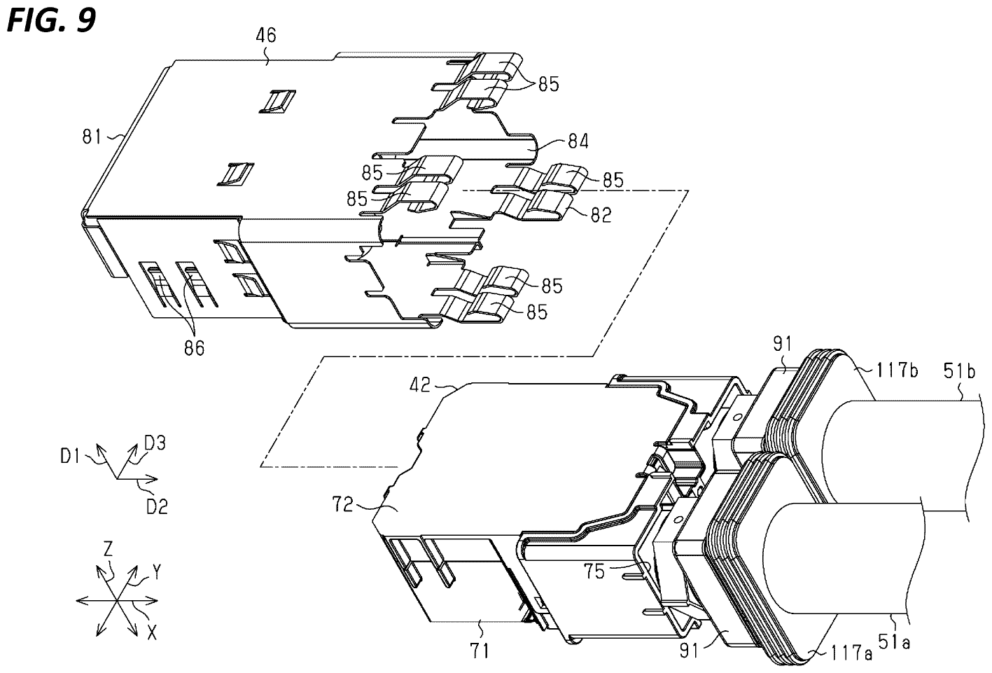

As illustrated in FIGS. 5 and 9, the lid member 72 is detachably attached to the inside housing body 71 from the direction opposite to the first direction D1 so as to enclose the opening of the storage recess portion 73.

### Configuration of Terminal 43

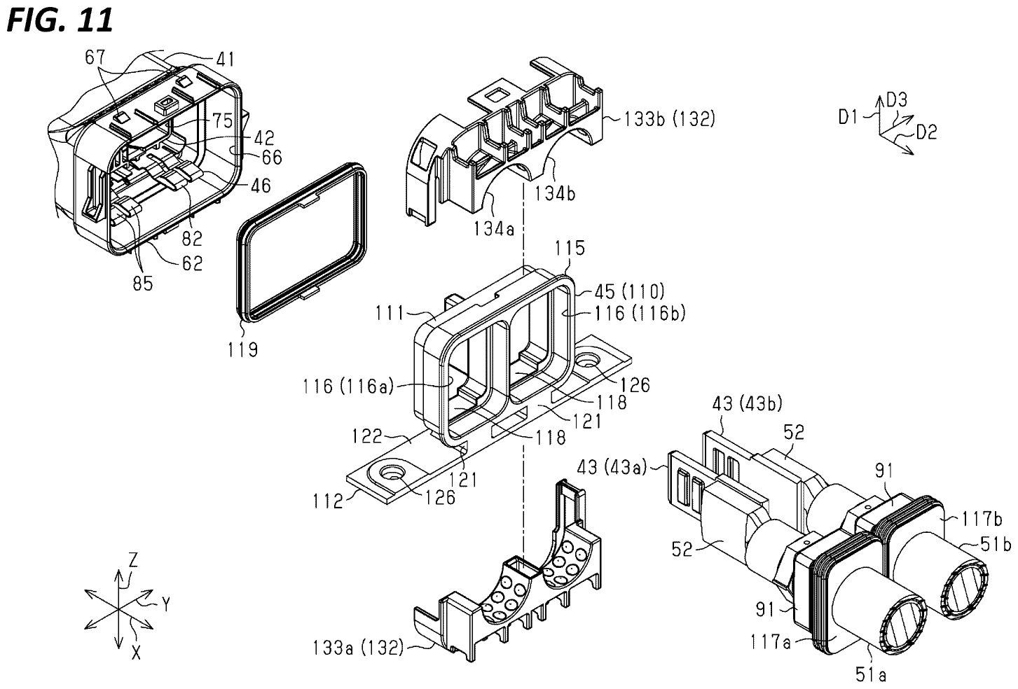

As illustrated in FIGS. 3 and 11, the terminals 43a and 43b are held in the inside housing 42. FIG. 3 illustrates only the terminal 43a. In FIG. 3, the terminal 43b is located on the far side in the drawing with respect to the terminal 43a. The terminals 43a and 43b are made of, for example, metallic materials such as copper, a copper alloy, aluminum, and an aluminum alloy. For example, the terminal 43a and the terminal 43b are identical in shape. The terminals 43a and 43b are, for example, plate-like in shape. The terminals 43a and 43b are disposed in the storage recess portion 73 such that the thickness directions of the terminals 43a and 43b extend along the third direction D3. Furthermore, for example, the terminal 43a and the terminal 43b are disposed in parallel at a certain distance from each other in the third direction D3 in the storage recess portion 73.

The terminals 43a and 43b are electrically connected to the wires 51a and 51b, respectively. For example, the ends of the wires 51a and 51b are electrically connected to the proximal-end regions of the terminals 43a and 43b, respectively. The proximal ends of the terminals 43a and 43b are ends oriented in the second direction D2 among both ends of the terminals 43a and 43b in the x-axis direction. The distal ends of the terminals 43a and 43b are ends oriented opposite to the second direction D2 among both ends of the terminals 43a and 43b in the x-axis direction. The terminal 43a and the wire 51a are joined by, for example, crimping, welding such as ultrasonic welding or laser welding, and other known joining methods. The terminal 43b and the wire 51b are also joined by a similar joining method.

The terminal 43a is inserted with one end of the wire 51a into the storage recess portion 73 from the wire through hole 75. Moreover, the terminal 43b is inserted with one end of the wire 51b into the storage recess portion 73 from the wire through hole 75. An electrically connected portion between the terminal 43a and the wire 51a and an electrically connected portion between the terminal 43b and the wire 51b are disposed in the inside housing 42.

When the connector 40 and the mating connector 20 are connected, the mating terminals 22a and 22b inserted from the first opening 63 into the connector 40 in the first direction D1 are inserted into the inside housing 42 from the respective terminal insertion openings 74. In the inside housing 42, the mating terminals 22a and 22b then overlap the terminals 43a and 43b in the third direction D3 and come into contact with the terminals 43a and 43b, respectively. Since the mating terminals 22a and 22b come into contact with the terminals 43a and 43b, the mating terminals 22a and 22b are electrically connected to the terminals 43a and 43b, respectively.

As illustrated in FIGS. 3 and 5, the connector 40 may include clip terminals 76 as many as the terminals 43a and 43b. The two clip terminals 76 are disposed in the inside housing 42. The clip terminals 76 have, for example, U-shapes opened opposite to the first direction D1 when viewed in the second direction D2. The clip terminals 76 are made of, for example, metallic materials such as copper, a copper alloy, aluminum, an aluminum alloy, and stainless steel. The clip terminals 76 are formed by pressing metallic plates.

One of the two clip terminals 76 holds the terminal 43a with the mating terminal 22a inserted into the inside housing 42, so that the mating terminal 22a is pressed to the terminal 43a. The other of the two clip terminals 76 holds the terminal 43b with the mating terminal 22b inserted into the inside housing 42, so that the mating terminal 22bis pressed to the terminal 43b.

### Configuration of Shield Shell 46

As illustrated in FIGS. 3 and 9, the shield shell 46 covers the outer surface of the inside housing 42. The shield shell 46 is disposed with the inside housing 42 in the outside housing 41. For example, the shield shell 46 is inserted with the inside housing 42 into the outside housing 41 from the second opening 66 along the second direction D2. The shield shell 46 has conductivity. For example, the shield shell 46 is formed by pressing a metallic plate.

The shield shell 46 has, for example, a cylindrical shape extending in the second direction D2. The shield shell 46 has a third end 81 and a fourth end 82 located opposite to the third end 81 in the second direction D2. The third end 81 of the shield shell 46 is closed. The shield shell 46 has a third opening 83 where the mating terminals 22a and 22b are inserted along the first direction D1. The third opening 83 overlaps the first opening 63 in the first direction D1.

Moreover, the shield shell 46 has a fourth opening 84 for the wires 51a and 51b to pass through along the second direction D2. The fourth opening 84 is located on the fourth end 82 of the shield shell 46. The fourth opening 84 overlaps the second opening 66 in the second direction D2.

As illustrated in FIG. 4, in an end region including the fourth opening 84, the shield shell 46 is electrically connected to the electromagnetic shield member 54 of each of the wires 51a and 51b. The shield shell 46 has a plurality of contact portions 85 in the end region including the fourth end 82. The contact portions 85 are formed by, for example, folding one end of the shield shell 46 in the second direction D2 to the inside of the shield shell 46. The contact portions 85 are placed along the outer edge of the fourth opening 84.

A connection shield member 91 electrically connected to the electromagnetic shield member 54 is attached to the wire 51a. For example, the connection shield member 91 has an annular shape. The wire 51a passes through the connection shield member 91 along the second direction D2. The electromagnetic shield member 54 exposed in the end region of the wire 51a is in contact with the connection shield member 91, so that the electromagnetic shield member 54 is electrically connected to the connection shield member 91. The connection shield member 91 is interposed between the end region including the fourth opening 84 on the shield shell 46 and the outer surface of the wire 51a. Moreover, some of the contact portions 85 come into contact with the outer surface of the connection shield member 91. The contact portions 85 come into contact with the connection shield member 91, so that the shield shell 46 is electrically connected to the electromagnetic shield member 54 via the connection shield member 91.

The same connection shield member 91 is also attached to the wire 51b. Like the electromagnetic shield member 54 of the wire 51a, the electromagnetic shield member 54 of the wire 51b is also electrically connected to the shield shell 46 via the connection shield member 91.

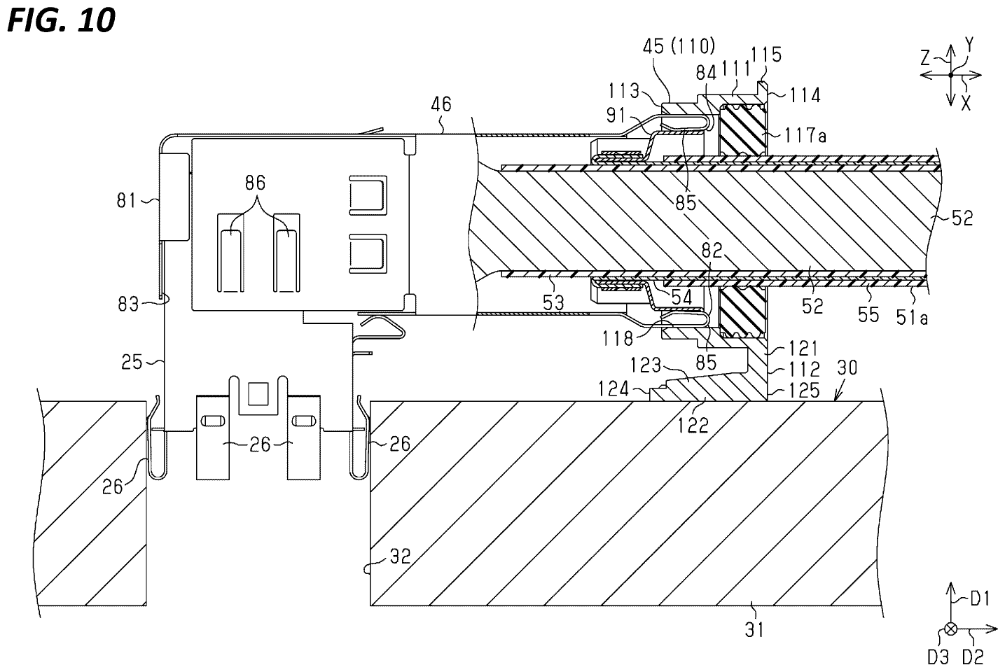

As illustrated in FIGS. 5 and 10, when the connector 40 and the mating connector 20 are connected to each other, the mating shell 25 is inserted into the shield shell 46 from the third opening 83 in the first direction D1. FIG. 10 illustrates a part constituting the electromagnetic shield structure in the connector 40 and the mating connector 20. When the connector 40 and the mating connector 20 are connected to each other, a part of the mating shell 25 is disposed in the shield shell 46. As illustrated in FIGS. 9 and 10, the shield shell 46 may have at least one contact piece 86 in contact with the mating shell 25 disposed in the shield shell 46. The contact piece 86 is formed by, for example, cutting a part of the shield shell 46 to the inside of the shield shell 46. The contact piece 86 presses the distal end region of the contact piece 86 to the outer surface of the mating shell 25 with the elastic force of the contact piece 86. The contact piece 86 comes into contact with the mating shell 25, so that the shield shell 46 and the mating shell 25 are electrically connected to each other. Thereafter, the electromagnetic shield member 54 of each of the wires 51a and 51b and the shield shell 46 are electrically connected to the housing 31 via the mating shell 25.

As illustrated in FIG. 3, in the internal space of the outside housing 41, the electrically connected portion between the electromagnetic shield member 54 and the shield shell 46 is disposed at a location where the third seal member 64 restrains entry of liquids such as water from the first opening 63. The electrically connected portion between the electromagnetic shield member 54 and the shield shell 46 includes, for example, a contact portion between the connection shield member 91 and the electromagnetic shield member 54, the connection shield member 91, and a contact portion between the connection shield member 91 and the contact portion 85.

### Configuration of Inner Housing Holder 45

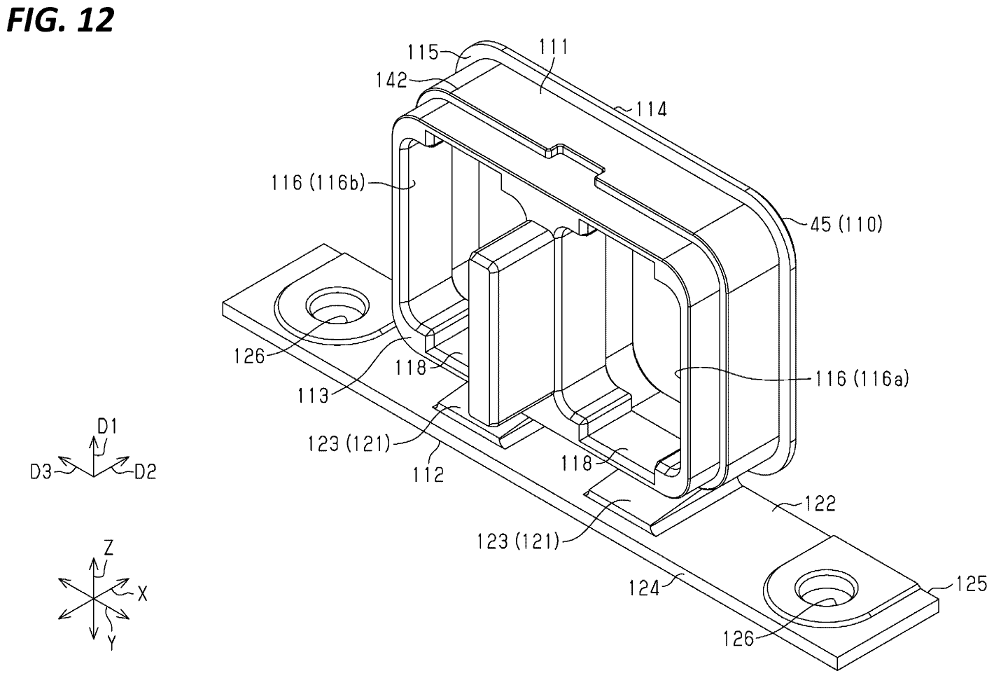

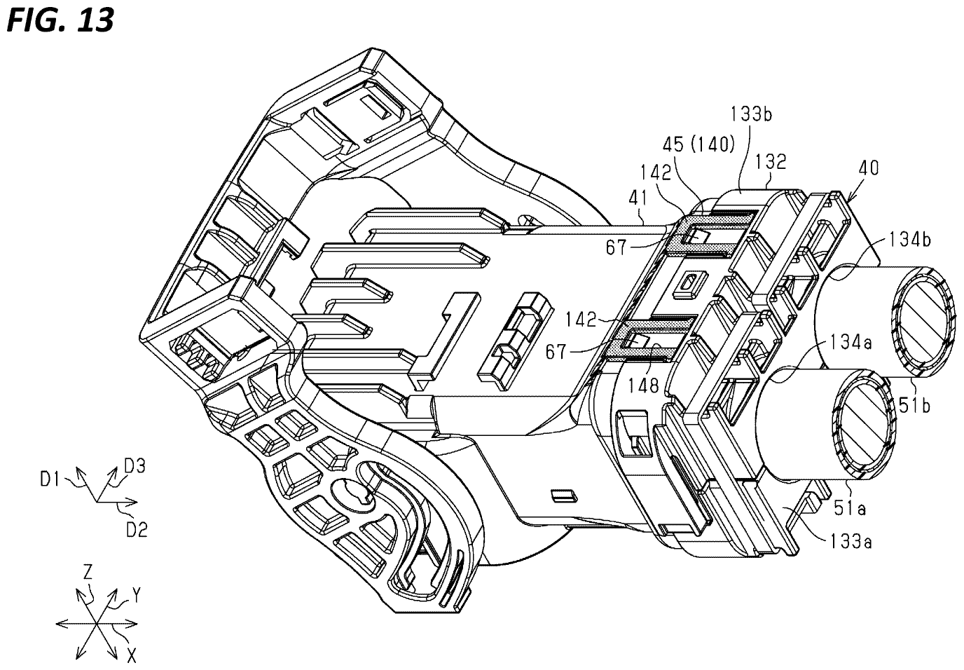

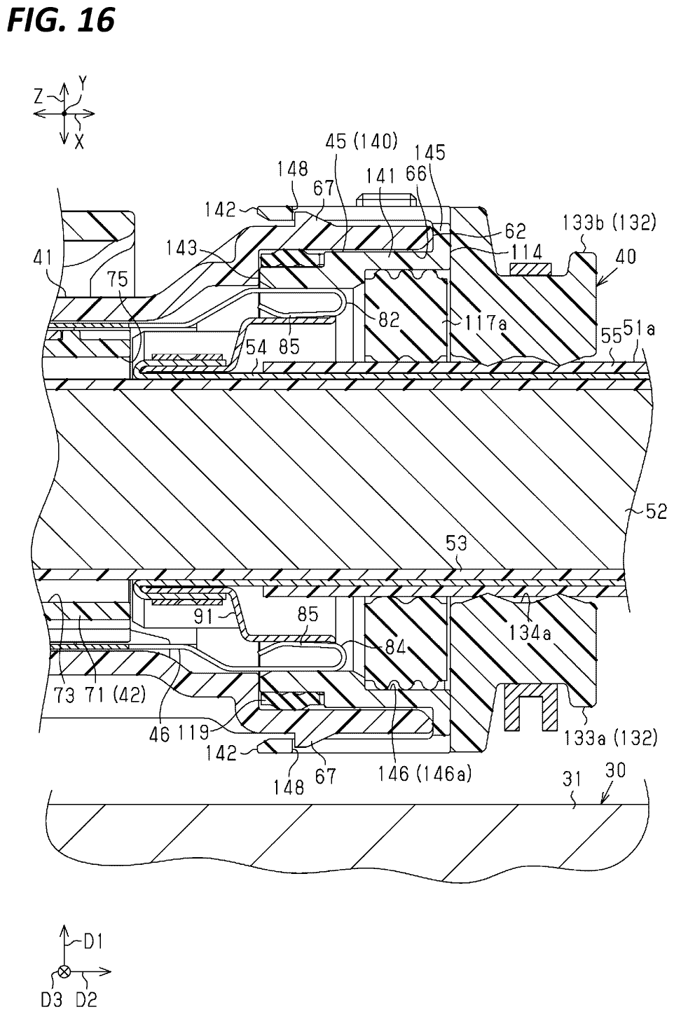

As illustrated in FIGS. 7, 11, 13, and 14, the inside housing holder 45 is attached to the second opening 66 of the outside housing 41. The inside housing holder 45 holds the inside housing 42 in the outside housing 41. In the connector 40, one of a first inner housing holder 110 and a second inner housing holder 140 can be selected as the inside housing holder 45. Hereinafter, the first inner housing holder 110 will be referred to as “first inside housing holder 110,” and the second inner housing holder 140 will be referred to as “second inside housing holder 140.” FIGS. 1 to 5, 7, 8, and 10 to 12 illustrate the connector 40 or a part of the connector 40 when the first inside housing holder 110 is selected as the inside housing holder 45. FIGS. 13 to 16 illustrate the connector 40 or a part of the connector 40 when the second inside housing holder 140 is selected as the inside housing holder 45. In FIG. 13, the second inside housing holder 140 is dotted.

### Configuration of First Inner Housing Holder 110

The case where the first inside housing holder 110 is selected as the inside housing holder 45 will be first described below.

As illustrated in FIGS. 4, 11, and 12, the first inside housing holder 110 has a first mounting portion 111 that is fitted into the second opening 66 and a fixed leg 112 that is fixed to the device 30 to which the mating connector 20 is attached. The first inside housing holder 110 prevents the inside housing 42 from moving out of the outside housing 41 from the second opening 66, by means of the first mounting portion 111 fitted into the second opening 66. For example, the first inside housing holder 110 is made of metal. The first inside housing holder 110 is formed by aluminum die casting. The first inside housing holder 110 is a single component formed by integrating the first mounting portion 111 and the fixed leg 112.

The first mounting portion 111 has, for example, a fifth end 113 and a sixth end 114. The fifth end 113 is an end located opposite to the second direction D2 on the first mounting portion 111. The sixth end 114 is an end opposite to the fifth end 113 in the second direction D2 and an end located in the second direction D2 on the first mounting portion 111.

For example, the first mounting portion 111 has a collar portion 115 that protrudes outward from an end region including the sixth end 114 in the first mounting portion 111. The collar portion 115 comes into contact with the second end 62 of the outside housing 41 from the direction opposite to the second direction D2. When the first inside housing holder 110 is attached to the second opening 66, the collar portion 115 is disposed outside the outside housing 41. In other words, the first mounting portion 111 has the fifth end 113 disposed in the outside housing 41 and the sixth end 114 disposed outside the outside housing 41.

The first mounting portion 111 has first through holes 116 for the wires 51a and 51b to pass through. For example, the first mounting portion 111 has the multiple first through holes 116 for the wires 51a and 51b to pass through, respectively. The first through hole 116 for the wire 51a to pass through is denoted as a first through hole 116a while the first through hole 116 for the wire 51b to pass through is denoted as a first through hole 116b. The first through holes 116a and 116b pass through the first mounting portion 111 in the second direction D2. The first through hole 116a and the first through hole 116b are arranged in the third direction D3.

As illustrated in FIGS. 4 and 11, the connector 40 may further include a plurality of first seal members 117a and 117b that provide sealing between the inner surfaces of the first through holes 116a and 116b and the outer surfaces of the wires 51a and 51b. The first seal members 117a and 117b has, for example, annular shapes surrounding the outer peripheries of the wires 51a and 51b when viewed in the second direction D2. The first seal members 117a and 117b are, for example, rubber rings. The wires 51a and 51b pass through the first seal members 117a and 117b, respectively, in the second direction D2. The first seal members 117a and 117b are disposed in the first through holes 116aand 116b, respectively. Furthermore, the first seal members 117a and 117b are interposed between the inner surfaces of the first through holes 116a and 116b and the outer surfaces of the wires 51a and 51b. The first seal members 117a and 117b are placed in contact with the outer surfaces of the wires 51a and 51b so as to surround the wires 51a and 51b, respectively. Furthermore, the first seal members 117a and 117b are placed in contact with the overall inner surfaces of the first through holes 116a and 116b, respectively. The first seal member 117a restrains liquids such as water from entering the inside of the outside housing 41 from a portion between the outer surface of the wire 51a and the inner surface of the first through hole 116a. The first seal member 117brestrains liquids such as water from entering the inside of the outside housing 41 from a portion between the outer surface of the wire 51b and the inner surface of the first through hole 116b.

As illustrated in FIGS. 4, 11, and 12, the first inside housing holder 110 may have contact portions 118 that are electrically connected to the shield shell 46 by making contact with the shield shell 46. For example, the first inside housing holder 110 has the contact portions 118 in the first mounting portion 111. The first inside housing holder 110 has the contact portions 118 on, for example, the respective inner surfaces of the first through holes 116a and 116b. The positions of the contact portions 118 in the y-axis direction are shifted opposite to the second direction D2 with respect to the positions of the first seal members 117a and 117b in the y-axis direction. The contact portions 118 are, for example, end regions including the fifth end 113 on the respective inner surfaces of the first through holes 116a and 116b.

When the first inside housing holder 110 is attached to the second opening 66 of the outside housing 41, the end regions including the fourth end 82 on the shield shell 46 are inserted into the first through holes 116a and 116b, respectively, in the second direction D2. For example, the shield shell 46 has the contact portions 85 inserted into the first through holes 116a and 116b, respectively. The contact portion 85 inserted into the first through hole 116a comes into contact with the contact portion 118 provided on the inner surface of the first through hole 116a. The contact portion 85 inserted into the first through hole 116b comes into contact with the contact portion 118 provided on the inner surface of the first through hole 116b. The contact portions 118 come into contact with the contact portions 85, so that the first inside housing holder 110 is electrically connected to the shield shell 46.

The connector 40 may further include a second seal member 119 that provides sealing between the outer surface of the first mounting portion 111 and the inner surface of the outside housing 41. The second seal member 119 has an annular shape surrounding the outer periphery of the first mounting portion 111. The second seal member 119 is, for example, a rubber ring. The second seal member 119 is interposed between the inner surface of the outside housing 41 and the outer surface of the first mounting portion 111 in the outside housing 41. Specifically, the second seal member 119 is interposed between the inner surface of an end region including the second end 62 and the outer surface of the first mounting portion 111 in the outside housing 41. The second seal member 119 is placed in contact with the overall outer surface of the first mounting portion 111. Furthermore, the second seal member 119 is placed in contact with the overall inner surface of the outside housing 41. The second seal member 119 restrains liquids such as water from entering the inside of the outside housing 41 from a portion between the outer surface of the first mounting portion 111 and the inner surface of the outside housing 41. In other words, the second seal member 119 restrains liquids such as water from entering the inside of the outside housing 41 from the second opening 66.

In the internal space of the outside housing 41, the electrically connected portion between the electromagnetic shield member 54 and the shield shell 46 is disposed at a location where the second seal member 119 restrains entry of liquids such as water from the second opening 66. In the internal space of the outside housing 41, the electrically connected portion between the first inside housing holder 110 and the shield shell 46 is disposed at a location where the second seal member 119 restrains entry of liquids such as water from the second opening 66. Moreover, the electrically connected portion between the first inside housing holder 110 and the shield shell 46 is, for example, a contact portion between the contact portion 118 and the contact portion 85.

In the connector 40, the electrically connected portion between the electromagnetic shield member 54 and the shield shell 46, the electrically connected portion between the first inside housing holder 110 and the shield shell 46, and the electrically connected portion between the mating shell 25 and the shield shell 46 are disposed at, for example, locations in the internal space of the outside housing 41 where the first seal members 117a and 117b, the second seal member 119, and the third seal member 64 restrain entry of liquid from the first opening 63 and the second opening 66.

The fixed leg 112 extends from the first mounting portion 111 to the outside of the outer housing 41. The fixed leg 112 includes, for example, two support portions 121 extending from the collar portion 115 and a mounting portion 122 integrated with the distal ends of the two support portions 121. The fixed leg 112 has, for example, a seventh end 124 and an eighth end 125. The seventh end 124 is an end located opposite to the second direction D2 on the fixed leg 112. The eighth end 125 is an end opposite to the seventh end 124 in the second direction D2 and an end located in the second direction D2 on the fixed leg 112.

The two support portions 121 extend opposite to the first direction D1 from one end located opposite to the first direction D1 on the collar portion 115. The two support portions 121 are separated from each other in the third direction D3. The support portion 121 has a connection portion 123 extending opposite to the second direction D2 on the distal end of the support portion 121. The distal end of the support portion 121 is an end located opposite to the first direction D1 on the support portion 121. The mounting portion 122 is integrated with ends located opposite to the first direction D1 on the two connection portions 123. The mounting portion 122 is, for example, plate-like in shape with the thickness direction along the first direction D1.

As illustrated in FIG. 4, a width W1 of the first mounting portion 111 in the second direction D2 is equal to or smaller than a width W2 of the fixed leg 112 in the second direction D2. For example, the first mounting portion 111 is placed in the range of the width W2 of the fixed leg 112 in the second direction D2. For example, the seventh end 124 of the fixed leg 112 is shifted opposite to the second direction D2 with respect to the fifth end 113 of the first mounting portion 111. Moreover, the eighth end 125 of the fixed leg 112 is located at the same position as the sixth end 114 of the first mounting portion 111 in the second direction D2.

As illustrated in FIG. 2, for example, the width of the mounting portion 122 in the third direction D3 is larger than that of the outside housing 41 in the third direction D3. In other words, the width of the fixed leg 112 in the third direction D3 is larger than that of the outside housing 41 in the third direction D3. FIG. 2 is a plan view of the connector 40 viewed in a direction opposite to the first direction D1. For example, the outside housing 41 is placed in the range of the width of the fixed leg 112 in the third direction D3. Moreover, the mounting portion 122 protrudes on both sides of the outside housing 41 in the third direction D3 when viewed in a direction opposite to the first direction D1.

For example, the fixed leg 112 has fixing holes 126 for fastening members 131 to pass through to fix the fixed leg 112 to the housing 31. The fixed leg 112 has, for example, the two fixing holes 126. The number of fixing holes 126 provided on the fixed leg 112 is not limited to two and may be one or three or more. For example, the fixing holes 126 are provided on both sides of the outside housing 41 in the third direction D3 when viewed in the first direction D1.

As illustrated in FIGS. 7 and 11, the connector 40 may include a back retainer 132 to be attached to an end region including the second end 62 on the outside housing 41. The back retainer 132 prevents the first seal members 117a and 117b from falling from the second opening 66. Moreover, the back retainer 132 prevents the first inside housing holder 110 from falling from the outside housing 41. The back retainer 132 includes two separate retainers 133a and 133b that are separated in the first direction D1. The back retainer 132 has two wire through holes 134a and 134b arranged in the third direction D3. The wires 51a and 51b are drawn out of the outside housing 41 through the wire through holes 134a and 134b, respectively.

As illustrated in FIGS. 2 and 3, the first inside housing holder 110 does not have any portion placed out of the back retainer 132 in the second direction D2. In other words, one end of the back retainer 132 in the second direction D2 is shifted in the second direction D2 with respect to one end of the first inside housing holder 110 in the second direction D2.

The first inside housing holder 110 is fixed to the housing 31 of the device 30 with the fastening members 131 passing through the fixing holes 126. The fastening member 131 is, for example, a bolt. The fastening member 131 is not limited to a bolt and may be, for example, a screw. The first inside housing holder 110 is fixed to the housing 31 while the mounting portion 122 is in contact with the surface of the housing 31. Thus, the first inside housing holder 110 is electrically connected to the housing 31.

### Configuration of First Second Inner Housing Holder 140

Next, the case where the second inside housing holder 140 is selected as the inside housing holder 45 will be described below.

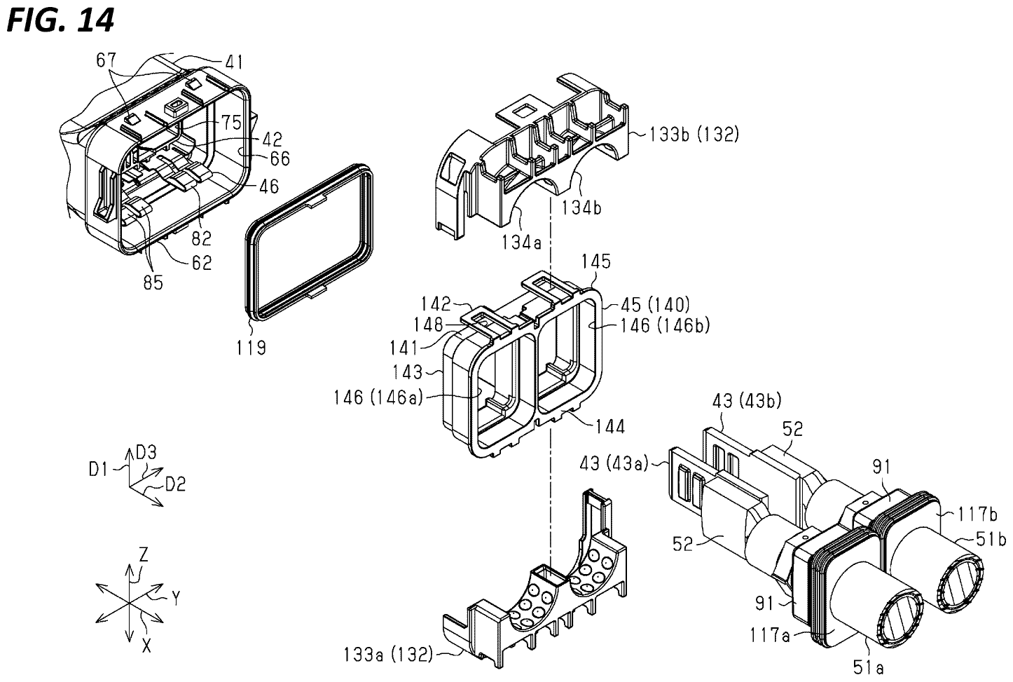

As illustrated in FIGS. 14, 15, and 16, the second inside housing holder 140 has a second mounting portion 141 that is fitted into the second opening 66 and engaging claws 142 for attaching the second inside housing holder 140 to the outside housing 41. The second inside housing holder 140 prevents the inside housing 42 from moving out of the outside housing 41 from the second opening 66, by means of the second mounting portion 141 fitted into the second opening 66. For example, the second inside housing holder 140 is made of synthetic resin. The second inside housing holder 140 is a single component formed by integrating the second mounting portion 141 and the engaging claws 142.

For example, the second mounting portion 141 are identical in shape and size to the first mounting portion 111. The second mounting portion 141 has, for example, a ninth end 143 and a tenth end 144. The ninth end 143 is an end located opposite to the second direction D2 on the second mounting portion 141. The tenth end 144 is an end opposite to the ninth end 143 in the second direction D2 and an end located in the second direction D2 on the second mounting portion 141.

For example, the second mounting portion 141 has a collar portion 145 that protrudes outward from an end region including the tenth end 144 in the second mounting portion 141. The collar portion 145 has the same shape as the collar portion 115 of the first mounting portion 111. The collar portion 145 comes into contact with the second end 62 of the outside housing 41. When the second inside housing holder 140 is attached to the second opening 66, a portion inside the collar portion 145 is disposed outside the outside housing 41. In other words, the second mounting portion 141 has the ninth end 143 disposed in the outside housing 41 and the tenth end 144 disposed outside the outside housing 41.

The second mounting portion 141 has second through holes 146 for the wires 51a and 51b to pass through. For example, the second mounting portion 141 has the multiple second through holes 146 for the wires 51a and 51b to pass through, respectively. The second through hole 146 for the wire 51a to pass through is denoted as a second through hole 146a while the second through hole 146 for the wire 51b to pass through is denoted as a second through hole 146b. The second through holes 146a and 146b are identical in shape and size to the first through holes 116a and 116b, respectively. The second through hole 146a and the second through hole 146b are arranged in the third direction D3.

When the second inside housing holder 140 is selected, the first seal members 117a and 117b provide sealing between the inner surfaces of the second through holes 146a and 146b and the outer surfaces of the wires 51a and 51b. In this case, the first seal members 117a and 117b are disposed in the second through holes 146a and 146b, respectively. Furthermore, the first seal members 117a and 117b are interposed between the inner surfaces of the second through holes 146a and 146b and the outer surfaces of the wires 51a and 51b. Moreover, the first seal members 117a and 117b are placed in contact with the overall inner surfaces of the second through holes 146a and 146b, respectively. The first seal member 117a restrains liquids such as water from entering the inside of the outside housing 41 from a portion between the outer surface of the wire 51a and the inner surface of the second through hole 146a. The first seal member 117b restrains liquids such as water from entering the inside of the outside housing 41 from a portion between the outer surface of the wire 51b and the inner surface of the second through hole 146b.

When the second inside housing holder 140 is selected, the second seal member 119 provides sealing between the outer surface of the second mounting portion 141 and the inner surface of the outside housing 41. In this case, the second seal member 119 is interposed between the inner surface of the outside housing 41 and the outer surface of the second mounting portion 141. The second seal member 119 is placed in contact with the overall outer surface of the second mounting portion 141. The second seal member 119 restrains liquids such as water from entering the inside of the outside housing 41 from a portion between the outer surface of the second mounting portion 141 and the inner surface of the outside housing 41. In the internal space of the outside housing 41, the electrically connected portion between the electromagnetic shield member 54 and the shield shell 46 is disposed at a location where the second seal member 119 restrains entry of liquids such as water from the second opening 66.

The second inside housing holder 140 has, for example, the multiple engaging claws 142. The second inside housing holder 140 has, for example, two of the engaging claws 142 on each side of the second mounting portion 141 in the first direction D1, so that the total number of engaging claws 142 is four. The engaging claws 142 extend from the collar portion 145 in a direction opposite to the second direction D2. The engaging claws 142 are elastically deformable. The engaging claw 142 has an engaging hole 148 that passes through the engaging claw 142 in the first direction D1.

As illustrated in FIGS. 13 and 14, the outside housing 41 may include a plurality of engaging protrusions 67 fitted into the engaging holes 148 provided on the engaging claws 142. For example, the outside housing 41 has two of the engaging protrusions 67 on each end of the outside housing 41 in the first direction D1, so that the total number of engaging protrusions 67 is four. The engaging protrusions 67 protrude from the outer surface of an end region including the second end 62 on the outside housing 41. The second inside housing holder 140 is detachably attached to the outside housing 41 by fitting the engaging protrusions 67 into the engaging holes 148 of the engaging claws 142. Moreover, the second inside housing holder 140 prevents the inside housing 42 from moving out of the outside housing 41 from the second opening 66, by means of the second mounting portion 141 fitted into the second opening 66. Furthermore, like the first inside housing holder 110, the second inside housing holder 140 is prevented from falling from the outside housing 41 by the back retainer 132.

### Effects of the Embodiment

The effects of the present embodiment will be described below.

(1) The connector 40 includes the outside housing 41 made of synthetic resin, the outside housing 41 having a first opening 63 where the mating terminals 22a and 22b provided on the mating connector 20 are inserted along the first direction D1 and a second opening 66 for the wires 51a and 51b to pass through along the second direction D2. The connector 40 includes the inside housing 42 that is made of synthetic resin and is disposed in the outside housing 41, and the terminals 43a and 43b that are held in the inside housing 42 and are electrically connected to the wires 51a and 51b, the mating terminals 22a and 22b being electrically connected to the terminals 43a and 43b. The connector 40 further includes the inside housing holder 45 that is attached to the second opening 66 to hold the inside housing 42 in the outside housing 41. One of the first inside housing holder 110 and the second inside housing holder 140 is selectable as the inside housing holder 45. The first inside housing holder 110 includes the first mounting portion 111 that has the first through holes 116 for the wires 51a and 51b to pass through and is fitted into the second opening 66. The first inside housing holder 110 further includes the fixed leg 112 that extends from the first mounting portion 111 to the outside of the outside housing 41 and is fixed to the device 30, the mating connector 20 being attached to the device 30. The second inside housing holder 140 includes the second mounting portion 141 that has the second through holes 146 for the wires 51a and 51b to pass through and is fitted into the second opening 66.

With this configuration, when the first inside housing holder 110 is selected as the inside housing holder 45, the fixed leg 112 can be fixed to the device 30. Specifically, the first inside housing holder 110 attached to the second opening 66 for the wires 51aand 51b to pass through can be fixed to the device 30. When the fixed leg 112 is fixed to the device 30, the outside housing 41 having the attached first inside housing holder 110 and the inside housing 42 disposed inside the outside housing 41 are integrated with the device 30 and thus are difficult to move relative to the device 30. This can suppress vibrations of the outside housing 41 and the inside housing 42 when the vibrations are caused by the vibrations of the wires 51a and 51b. When the connector 40 and the mating connector 20 are connected to each other, vibrations of the wires 51a and 51b are restrained from causing a relative movement of the terminals 43a and 43b, which are held in the inside housing 42, and the mating terminals 22a and 22b. This can suppress wearing of the contact portion between the terminals 43a and 43b and the mating terminals 22a and 22b. As described above, when the first inside housing holder 110 is selected as the inside housing holder 45, the connector 40 can be provided with a vibration-resistant structure.

The first inside housing holder 110 is a component obtained by adding the function of providing the connector 40 having a vibration-resistant structure to a component having the function of holding the inside housing 42 in the outside housing 41. In other words, the first inside housing holder 110 is not a component only for providing the connector 40 with a vibration-resistant structure. Therefore, an increase in the number of components can be suppressed as compared with the case where a component only for providing the connector 40 with a vibration-resistant structure is added to the connector 40.

Furthermore, the second inside housing holder 140 does not include the fixed leg 112. Thus, the connector 40 can be manufactured without a vibration-resistant structure by selecting the second inside housing holder 140 as the inside housing holder 45.

Accordingly, in the connector 40 configured such that the mating terminals 22a and 22b to be connected to the terminals 43a and 43b are inserted in a direction crossing the extension direction of the wires 51a and 51b, the presence or absence of a vibration- resistant structure can be selected without increasing the number of components.

(2) The first inside housing holder 110 is made of metal. With this configuration, the first inside housing holder 110 can have greater rigidity as compared with the first inside housing holder 110 made of synthetic resin. This can further suppress vibrations of the outside housing 41 and the inside housing 42 when the vibrations are caused by the vibrations of the wires 51a and 51b. When the connector 40 and the mating connector 20 are connected to each other, vibrations of the wires 51a and 51b can be further restrained from causing a relative movement of the terminals 43a and 43b, which are held in the inside housing 42, and the mating terminals 22a and 22b. This can further suppress wearing of the contact portion between the terminals 43a and 43b and the mating terminals 22a and 22b.

(3) The first inside housing holder 110 is formed by aluminum die casting. With this configuration, the first inside housing holder 110 made of metal can be easily manufactured.

(4) The second inside housing holder 140 is made of synthetic resin. With this configuration, the second inside housing holder 140 can be inexpensively manufactured with light weight as compared with the case of the second inside housing holder 140 being made of metal.

(5) The connector 40 further includes the shield shell 46 that has conductivity and covers the outer surface of the inside housing 42. The first inside housing holder 110 has the contact portions 118 that are electrically connected to the shield shell 46 by making contact with the shield shell 46. With this configuration, when the first inside housing holder 110 is selected as the inside housing holder 45, the first inside housing holder 110 and the shield shell 46 are electrically connected to each other. When the housing 31 of the device 30 where the mating connector 20 is attached has conductivity, the first inside housing holder 110 and the housing 31 can be electrically connected to each other by fixing the fixed leg 112 in contact with the housing 31. Thus, the shield shell 46 can be electrically connected to the housing 31 via the first inside housing holder 110. Consequently, the shield shell 46 can be electrically connected to the housing 31 via the first inside housing holder 110 as well as the mating shell 25. Thus, the reliability of an electromagnetic shield function can be increased in the connector 40.

(6) The fixed leg 112 has fixing holes 126 for the fastening members 131 to pass through, the fastening members 131 fixing the fixed leg 112 to the device 30. The fixing holes 126 are provided on both sides of the outside housing 41 in a direction orthogonal to the second direction D2, that is, in the third direction D3 when viewed in the first direction D1. With this configuration, the first inside housing holder 110 can be stably fixed to the device 30 as compared with the case of the single fixing hole 126 or the case of the fixing holes 126 provided only on one side of the outside housing 41 in the third direction D3 when viewed in the first direction D1. This can further suppress vibrations of the outside housing 41 and the inside housing 42 when the vibrations are caused by the vibrations of the wires 51a and 51b. When the connector 40 and the mating connector 20 are connected to each other, vibrations of the wires 51a and 51b can be further restrained from causing a relative movement of the terminals 43a and 43b, which are held in the inside housing 42, and the mating terminals 22a and 22b.

(7) The first mounting portion 111 is placed in the range of the width W2 of the fixed leg 112 in the second direction D2. With this configuration, the width of the first inside housing holder 110 can be reduced in the second direction D2 as compared with the case where the first mounting portion 111 is placed out of the range of the width W2 of the fixed leg 112 in the second direction D2. Thus, upsizing of the connector 40 can be suppressed in the second direction D2.

(8) The first seal members 117a and 117b are further provided for sealing between the inner surfaces of the first through holes 116a and 116b or the inner surfaces of the second through holes 146a and 146b and the outer surfaces of the wires 51a and 51b. With this configuration, the first seal members 117a and 117b can provide sealing separately between the outer surfaces of the wires 51a and 51b and the inner surfaces of the first through holes 116a and 116b or the second through holes 146a and 146b. For example, in some cases, the terminals 43a and 43b and the wires 51a and 51b are connected to each other after the first seal members 117a and 117b are attached to the wires 51a and 51b. In this case, when the terminals 43a and 43b and the wires 51a and 51b are connected to each other, the wires 51a and 51b can be connected without being sealed with the seal members, that is, in a separated state. Thus, the terminals 43a and 43b and the wires 51a and 51b can be easily connected to each other.

(9) The outside housing 41 has a cylindrical shape extending in the second direction D2 and has the first end 61 and the second end 62 located opposite to the first end 61 in the second direction D2. The first end 61 is closed. The second opening 66 is located on the second end 62. The first opening 63 is located between the first end 61 and the second end 62. The second seal member 119 is further provided for sealing between the outer surface of the first mounting portion 111 or the outer surface of the second mounting portion 141 and the inner surface of the outside housing 41. With this configuration, the second seal member 119 can restrain liquids such as water from entering the inside of the outside housing 41 from a portion between the outer surface of the first mounting portion 111 or the second mounting portion 141 and the inner surface of the outside housing 41.

(10) The wires 51a and 51b are shield wires, each including the core wire 52, the first insulating coating 53 covering the outer periphery of the core wire 52, the electromagnetic shield member 54 that has conductivity and covers the outer periphery of the first insulating coating 53, and the second insulating coating 55 covering the outer periphery of the electromagnetic shield member 54. The connector 40 further includes the shield shell 46 that has conductivity and covers the outer surface of the inside housing 42. The electromagnetic shield member 54 is electrically connected to the shield shell 46. In the internal space of the outside housing 41, the electrically connected portion between the electromagnetic shield member 54 and the shield shell 46 is disposed at a location where the second seal member 119 restrains entry of liquid from the second opening 66. With this configuration, the adhesion of liquids such as water to the electrically connected portion between the electromagnetic shield member 54 and the shield shell 46 can be suppressed.

(11) The connector 40 further includes the third seal member 64 that is interposed between the outside housing 41 and the mating connector 20 and restrains liquid from entering the inside of the outside housing 41 from the first opening 63. In the internal space of the outside housing 41, the electrically connected portion between the electromagnetic shield member 54 and the shield shell 46 is disposed at a location where the third seal member 64 restrains entry of liquid from the first opening 63. With this configuration, the adhesion of liquids such as water to the electrically connected portion between the electromagnetic shield member 54 and the shield shell 46 can be suppressed.

(12) When a conventional rattle preventing member is applied to the connector to which the mating connectors are inserted in a direction crossing the extension direction of the wires, vibrations can be suppressed in a direction orthogonal to the insertion direction of the mating terminals. However, connector vibrations are hard to reduce in a direction orthogonal to the lengthwise direction of the wires. Furthermore, when large-diameter wires like a high voltage cable are used, the application of the conventional rattle preventing member may fail to prevent the vibrating wires from vibrating the connector with respect to the device to which the mating connector is attached. In contrast, in the connector 40, the fixed leg 112 is fixed to the housing 31, thereby suppressing vibrations of the connector 40 when the vibrations are caused by the vibrations of the wires 51a and 51b. This can suppress vibrations of the connector 40 in a direction orthogonal to the first direction D1 and vibrations of the connector 40 in a direction orthogonal to the lengthwise direction of the wires 51a and 51b, that is, the second direction D2. Moreover, the fixed leg 112 is fixed to the housing 31, thereby suppressing a movement of the connector 40 relative to the housing 31. Therefore, even if the wires 51a and 51b are high voltage cables having large diameters, vibrations of the wires 51a and 51b can be restrained from vibrating the connector 40 with respect to the housing 31.

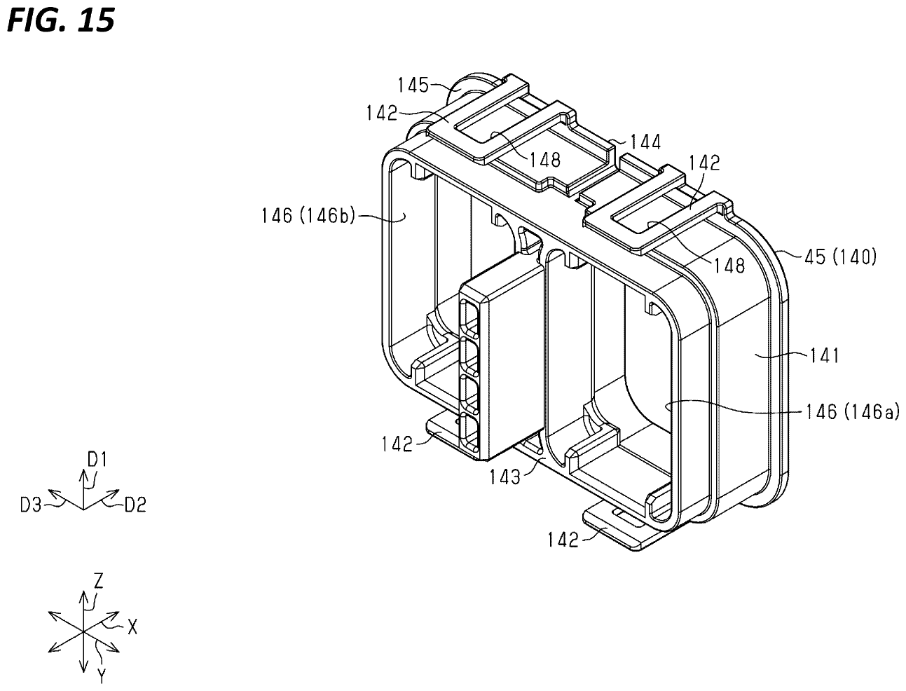

The present embodiment can be implemented with the modifications below. The present embodiment and the following modification examples can be implemented in combination unless technical contradictions arise.
The electrically connected portion between the electromagnetic shield member 54 and the shield shell 46 is not limited to the location of the foregoing embodiment if the connected portion is located in the internal space of the outer housing 41.
In the foregoing embodiment, the first mounting portion 111 has the two first through holes 116. However, the first mounting portion 111 may have the single first through hole 116 alone. In this case, the wires 51a and 51b pass through the single first through hole 116. Furthermore, in this case, the connector 40 includes a single first seal member alone. Moreover, the first seal member has two through holes: a through hole for the wire 51a to pass through and a through hole for the wire 51b to pass through. Likewise, the second mounting portion 141 may have a single second through hole 146 alone.
The connector 40 may be provided without at least one of the first seal members 117a and 117b, the second seal member 119, and the third seal member 64.
The number of terminals 43 provided on the connector 40 may be one or three or more. The number of mating terminals 22 provided on the mating connector 20 is not limited to two and may be changed according to the number of terminals 43 provided on the connector 40.
The first mounting portion 111 may be placed out of the range of the width W2 of the fixed leg 112 in the second direction D2. For example, the first mounting portion 111 may have a portion that does not overlap the fixed leg 112 and the first direction D1. Alternatively, for example, the fixed leg 112 may be placed in the range of the first mounting portion 111 in the second direction D2.
The fixing hole 126 may be provided only on one side of the outside housing 41 in the third direction D3 when viewed in the first direction D1. Alternatively, the fixing hole 126 may be provided on at least one of both sides of the outside housing 41 in the second direction D2 when viewed in the first direction D1. In this case, the size and shape of the mounting portion 122 may be changed according to the position of the fixing hole 126.
The first inside housing holder 110 may be provided without the contact portions 118. The shapes of the first mounting portion 111 and the fixed leg 112 are not limited to the shapes of the foregoing embodiment. For example, the fixed leg 112 may have one or three or more support portions 121. Moreover, for example, the fixed leg 112 may have the multiple mounting portions 122.
The second inside housing holder 140 is not always made of synthetic resin. For example, the second inside housing holder 140 may be made of metal.
The second inside housing holder 140 is not limited to the shape of the foregoing embodiment if the second inside housing holder 140 includes the second mounting portion 141. For example, the second inside housing holder 140 may be provided without the engaging claws 142.
The first inside housing holder 110 is not always formed by aluminum die casting. For example, the first inside housing holder 110 may be formed by machining methods such as casting and cutting. Moreover, the first inside housing holder 110 may be made of synthetic resin. In this case, the first inside housing holder 110 may be made of synthetic resin materials including a filler.
As illustrated in FIGS. 14 and 15, the second inner housing holder 140 may be provided without the fixed leg to be fixed to the device 30 to which the mating connector 20 is attached, and the second inner housing holder 140 may be configured without being fixed to the device 30 or brought into direct contact with the device 30.
As illustrated in FIG. 4, in the first inner housing holder 110, the width of the support portion 121 in the first direction D1 may be larger than the thickness of the second end 62 of the outer housing 41 in the first direction D1, and a space for the insertion of the second end 62 of the outer housing 41 may be formed between the mounting portion 122 and the first mounting portion 111.
As illustrated in FIG. 3, the fixed leg 112 of the first inside housing holder 110 and the fixed part 24 of the mating housing 21 may each have a bottom or a sole to be fixed to the outer surface of the housing 31. As in the illustrated example, the bottom of the fixed leg 112 and the bottom of the fixed part 24 may be parallel to each other and may extend on a common plane.
As illustrated in FIGS. 3 and 14, the first mounting portion 111 of the first inner housing holder 110 and the second mounting portion 141 of the second inner housing holder 140 may be insertable into the second opening 66 of the same outer housing 41, and sealing may be provided between the outer surface of the first mounting portion 111 or the outer surface of the second mounting portion 141 and the inner surface of the outer housing 41 by the same second seal member 119.
As illustrated in FIGS. 3 and 14, the same wires 51a and 51b may be insertable into the first through holes 116a and 116b of the first inner housing holder 110 and the second through holes 146a and 146b of the second inner housing holder 140, and sealing may be provided between the inner surfaces of the first through holes 116a and 116b or the inner surfaces of the second through holes 146a and 146b and the outer surfaces of the wires 51a and 51b by the same first seal members 117a and 117b.

### List of Reference Numerals

20 Mating connector
21 Mating connector housing (mating housing)
22, 22a, 22b Mating terminal
23 Body part
24 Fixed part
25 Mating shield shell (mating shell)
26 Contact portion
27 Seal member
30 Device
31 Housing
32 Mounting hole
40 Connector
41 Outer housing (outside housing)
42 Inner housing (inside housing)
43, 43a, 43b Terminal
45 Inner housing holder (inside housing holder)
46 Shield shell
51a, 51b Wire
52 Core wire
53 First insulating coating
54 Electromagnetic shield member
55 Second insulating coating
61 First end
62 Second end
63 First opening
64 Third seal member
65 Cap
66 Second opening
67 Engaging protrusion
71 Inner housing body (inside housing body)
72 Lid member
73 Storage recess portion
74 Terminal insertion opening
75 Wire through hole
76 Clip terminal
81 Third end
82 Fourth end
83 Third opening
84 Fourth opening
85 Contact portion
86 Contact piece
91 Connection shield member
110 First inner housing holder (first inside housing holder)
111 First mounting portion
112 Fixed leg
113 Fifth end
114 Sixth end
115 Collar portion
116, 116a, 116b First through hole
117a, 117b First seal member
118 Contact portion
119 Second seal member
121 Support portion
122 Mounting portion
123 Connection portion
124 Seventh end
125 Eighth end
126 Fixing hole
131 Fastening member
132 Back retainer
133a, 133b Separate retainer
134a, 134b Wire through hole
140 Second inner housing holder (second inside housing holder)
141 Second mounting portion
142 Engaging claw
143 Ninth end
144 Tenth end
145 Collar portion
146, 146a, 146b Second through hole
148 Engaging hole

1. A connector comprising:
an outer housing made of synthetic resin, the outer housing having a first opening where a mating terminal provided on a mating connector is inserted along a first direction and a second opening for a wire to pass through along a second direction crossing the first direction;
an inner housing that is made of synthetic resin and is disposed in the outer housing;
a terminal that is held in the inner housing and is electrically connected to the wire, the mating terminal being electrically connected to the terminal; and
an inner housing holder that is attached to the second opening to hold the inner housing in the outer housing,
wherein one of a first inner housing holder and a second inner housing holder is selectable as the inner housing holder,
the first inner housing holder includes:
a first mounting portion that has a first through hole for the wire to pass through and is fitted into the second opening, and
a fixed leg that extends from the first mounting portion to outside of the outer housing and is fixed to a device, the mating connector being attached to the device, and
the second inner housing holder includes a second mounting portion that has a second through hole for the wire to pass through and is fitted into the second opening.

2. The connector according to claim 1, wherein the first inner housing holder is made of metal.

3. The connector according to claim 2, wherein the first inner housing holder is formed by aluminum die casting.

4. The connector according to claim 1, wherein the second inner housing holder is made of synthetic resin.

5. The connector according to claim 2, further comprising a shield shell that has conductivity and covers an outer surface of the inner housing,
wherein the first inner housing holder has a contact portion that is electrically connected to the shield shell by making contact with the shield shell.

6. The connector according to claim 1, wherein the fixed leg has fixing holes for fastening members to pass through, the fastening members fixing the fixed leg to the device, and
the fixing holes are provided on both sides of the outer housing in a direction orthogonal to the second direction when viewed in the first direction.

7. The connector according to claim 1, wherein the first mounting portion is placed in a range of a width of the fixed leg in the second direction.

8. The connector according to claim 1, further comprising a first seal member for sealing between an inner surface of the first through hole or an inner surface of the second through hole and an outer surface of the wire.

9. The connector according to claim 8, wherein the outer housing has a cylindrical shape extending in the second direction and has a first end and a second end located opposite to the first end in the second direction,
the first end is closed,
the second opening is located on the second end,
the first opening is located between the first end and the second end, and
a second seal member is further provided for sealing between an outer surface of the first mounting portion or an outer surface of the second mounting portion and an inner surface of the outer housing.

10. The connector according to claim 9, wherein the wire is a shield wire including a core wire, a first insulating coating covering an outer periphery of the core wire, an electromagnetic shield member that has conductivity and covers an outer periphery of the first insulating coating, and a second insulating coating covering an outer periphery of the electromagnetic shield member,
the connector further includes a shield shell that has conductivity and covers an outer surface of the inner housing,
the electromagnetic shield member is electrically connected to the shield shell, and
in an internal space of the outer housing, an electrically connected portion between the electromagnetic shield member and the shield shell is disposed at a location where the second seal member restrains entry of liquid from the second opening.

11. The connector according to claim 10, further comprising a third seal member that is interposed between the outer housing and the mating connector and restrains liquid from entering inside of the outer housing from the first opening,
wherein in the internal space of the outer housing, an electrically connected portion between the electromagnetic shield member and the shield shell is disposed at a location where the third seal member restrains entry of liquid from the first opening.
